(19) United States
(12) Patent Application Publication
(10) Pub. No.: US 2016/0069264 A1
(43) Pub. Date: Mar. 10, 2016

(54) Gas turbine engine with turbine cooling and combustor air preheating

(71) Applicants: Joseph D. Brostmeyer, Jupiter, FL (US); Justin T. Cejka, Palm Beach Gardens, FL (US); James P. Downs, Hobe Sound, FL (US)

(72) Inventors: Joseph D. Brostmeyer, Jupiter, FL (US); Justin T. Cejka, Palm Beach Gardens, FL (US); James P. Downs, Hobe Sound, FL (US)

(21) Appl. No.: 14/335,916

(22) Filed: Jul. 20, 2014

Related U.S. Application Data
(60) Provisional application No. 61/856,897, filed on Jul. 22, 2013.

(51) Int. Cl. F02C 7/143; F01K 23/10

(52) U.S. Cl. CPC F02C 7/143; F01K 23/10

(57) ABSTRACT

A gas turbine engine, especially an industrial gas turbine engine for electrical power production, where a second compressor is used to supply a second compressed air at a higher pressure to a stage of stator vanes in the turbine section of the engine for cooling of the stage of stator vanes, and where the heated compressed air used to cool the stator vanes is then discharged into the combustor to be burned with a fuel and produce a hot gas stream that is passed through the turbine. an intercooler can be used with the second compressor to lower the temperature of the second compressed air used for cooling the stator vanes.

### CROSS-REFERENCE TO RELATED APPLICATIONS

This application claims the benefit to Provisional Application No. 61/856,897 filed on Jul. 22, 2013 and entitled GAS TURBINE ENGINE WITH TURBINE COOLING AND COMBUSTOR AIR OPREHEATING.

### GOVERNMENT LICENSE RIGHTS

None.

### BACKGROUND OF THE INVENTION

1. Field of the Invention

The present invention relates generally to a gas turbine engine, and more specifically to a gas turbine engine with turbine cooling.

2. Description of the Related Art Including Information Disclosed Under 37 CFR 1.97 and 1.98

In a gas turbine engine, such as a large frame heavy-duty industrial gas turbine (IGT) engine, a hot gas stream generated in a combustor is passed through a turbine to produce mechanical work. The turbine includes one or more rows or stages of stator vanes and rotor blades that react with the hot gas stream in a progressively decreasing temperature. The efficiency of the turbine—and therefore the engine—can be increased by passing a higher temperature gas stream into the turbine. However, the turbine inlet temperature is limited to the material properties of the turbine, especially the first stage vanes and blades, and an amount of cooling capability for these first stage airfoils.

The first stage rotor blade and stator vanes are exposed to the highest gas stream temperatures, with the temperature gradually decreasing as the gas stream passes through the turbine stages. The first and second stage airfoils (blades and vanes) must be cooled by passing cooling air through internal cooling passages and discharging the cooling air through film cooling holes to provide a blanket layer of cooling air to protect the hot metal surface from the hot gas stream.

### BRIEF SUMMARY OF THE INVENTION

A gas turbine engine includes a second compressor driven by a motor to produce a higher compressed air pressure than the main compressor of the gas turbine engine, where the higher pressure compressed air is used to cool a stator vane in the turbine section, and then the heated compressed air is then discharged into the combustor to be burned with a fuel and produce a hot gas stream for the turbine.

In another embodiment, the second compressor includes an intercooler to produce the higher pressure compressed air but with a lower temperature prior to cooling the turbine stator vane.

In another embodiment, lower pressure compressed air is bled off from the main compressor at a lower stage and then passed through an intercooler prior to being discharged into a second compressor where the cooler compressed air is further increased in pressure and then passed through the turbine stator vane for cooling, and then the heated compressed air is introduced into the combustor.

In another embodiment, a Heat Recovery Steam Generator is used to supply water to an intercooler of the second compressor of the gas turbine engine to produce a cooler second compressed air that is used to cool the turbine stator vane prior to passing the heated compressed air from the stator vane into the combustor. The second compressor can be one compressor with an intercooler between stages, or two compressors with the intercooler between the two compressors.

### BRIEF DESCRIPTION OF THE SEVERAL VIEWS OF THE DRAWINGS

FIG. 1 shows a first embodiment of the gas turbine engine with turbine cooling of the present invention.

FIG. 2 shows a second embodiment of the gas turbine engine with turbine cooling of the present invention.

FIG. 3 shows a third embodiment of the gas turbine engine with turbine cooling of the present invention.

FIG. 4 shows a fourth embodiment of the gas turbine engine with turbine cooling of the present invention.

### DETAILED DESCRIPTION OF THE INVENTION

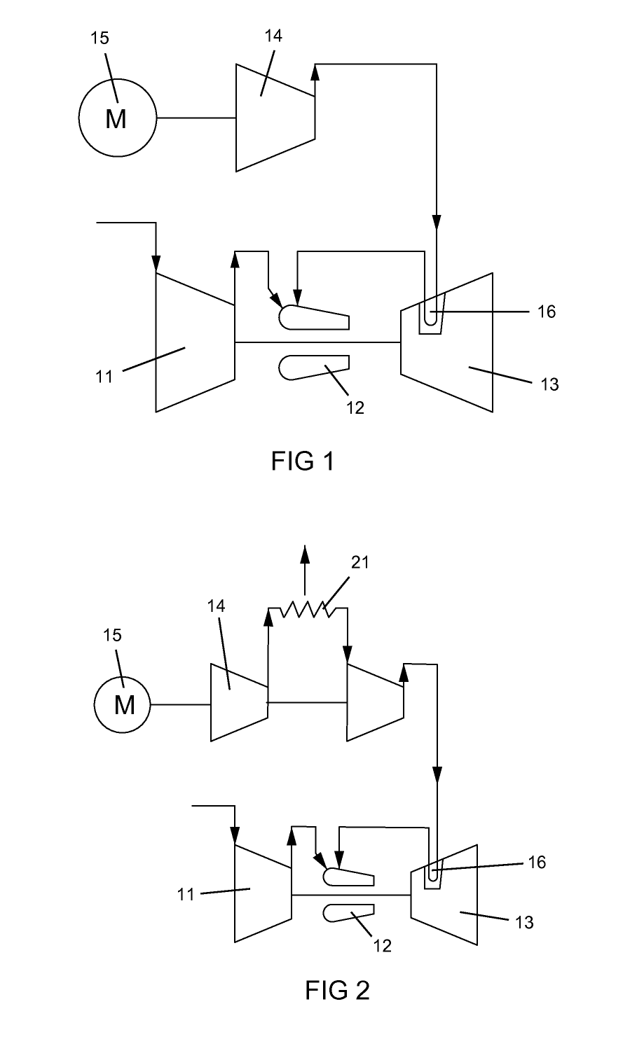

The present invention is a gas turbine engine with cooling of the turbine stator vanes. FIG. 1 shows a first embodiment of the present invention with a gas turbine engine having a compressor 11, a combustor 12 and a turbine 13. The turbine has a first stage of stator vanes 16 that are cooled. The compressor 11 compresses air that is then burned with a fuel in the combustor 12 to produce a hot gas stream that is passed through the turbine 13. A second compressor 14 is driven by a motor 15 to compress air at a higher pressure than from the first compressor 11. The higher compressed air is then passed through the stator vanes 16 in the turbine 13 for cooling, and the heated cooling air is then passed into the combustor 12 to be burned with the fuel and the compressed air from the first compressor 11.

The second compressor 14 produces higher pressure compressed air for cooling of the stator vanes 16 that can then be discharged into the combustor 12. Without the higher pressure, the cooling air for the stator vanes would lose pressure and not be high enough to pass into the combustor.

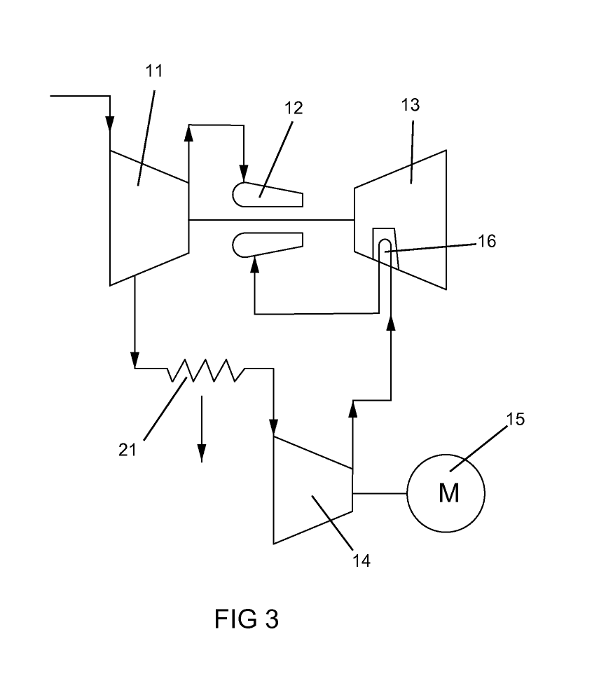

FIG. 2 shows a second embodiment of the present invention in which the second compressor (a multiple stage axial flow compressor) includes an inter-stage cooler 21 to cool the compressed air in order to increase the performance of the second compressor. The compressed air from the second compressed 14 with the inter-stage cooler 21 is then used to cool the stator vanes 16 and is then discharged into the combustor 12. The second compressor 14 with the inter-stage cooler produces a higher pressure cooling air than the first compressor 11 so that enough pressure remains after cooling of the stator vanes 16 to be discharged into the combustor 12.

FIG. 3 shows a third embodiment of the present invention where the cooling air for the stator vanes 16 is bled off from an early stage of the first compressor 11, passed through an inter-stage cooler 21, and then enters a second compressor 14 to be increased in pressure. The higher pressure air from the second compressor 14 is then passed through the stator vanes 16 for cooling, and then discharged into the combustor 12.

In the three embodiments, the first or main compressor 11 produces around 80% of the required air for the combustor 12. The second compressor 14 produces the remaining 20% for the combustor 12. In one industrial gas turbine engine studied, the first or main compressor 11 has a pressure ratio of 30 while the second compressor 14 has a pressure ratio of 40.

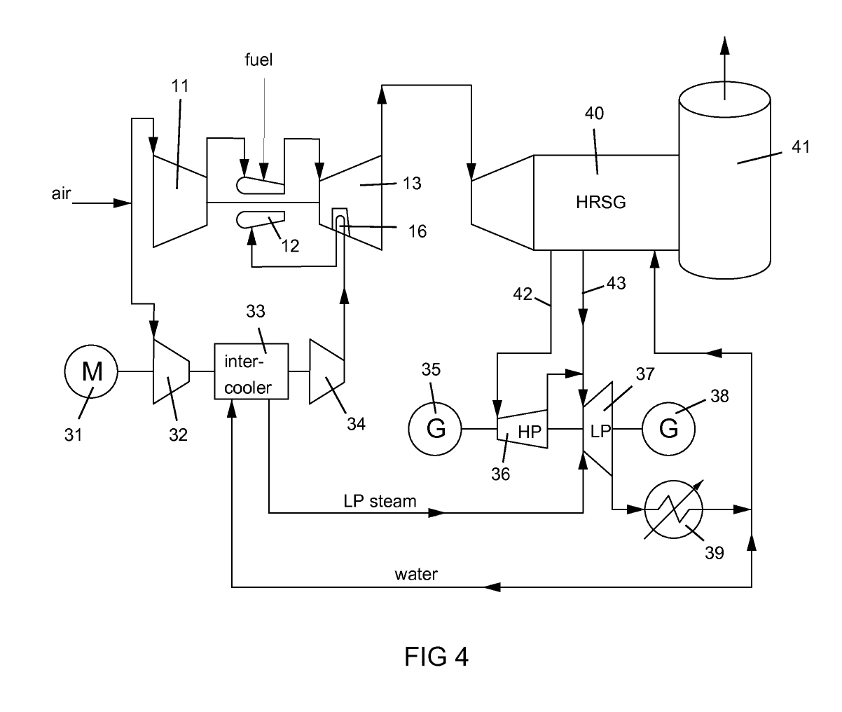

FIG. 4 shows another embodiment of the present invention with turbine cooling and an intercooler heat recovery. The gas turbine engine includes a compressor 11, a combustor 12 and a turbine 13 in which a turbine airfoil such as a stator vane 16 is cooled. Fuel is introduced into the combustor 12 to produce a hot gas stream that is passed through the turbine 13. A secondary flow external compression takes place in first and second compressors 32 and 34 driven by a motor 31. An intercooler/low pressure steam generator 33 is positioned between two compressors 32 and 34 or between stages of one compressor to cool the compressed air. A motor 31 drives both compressors 32 and 34 that compress air for use in cooling of the turbine airfoil 16.

The turbine 13 exhaust is used to produce steam in a Heat Recovery Steam Generator or HRSG 40. The HRSG 40 produces high pressure (HP) steam 42 that is delivered to a high pressure turbine 36 to drive a first electric generator 35. The HRSG 40 also produces low pressure (LP) steam 43 that is combined with LP steam from the HP turbine exhaust that flows into a low pressure (LP) turbine 37 that drives a second electric generator 38. A stack 41 discharges the leftover turbine exhaust after use in the HRSG 40. A condenser 39 condenses the steam discharged from the LP turbine 37 into water that then flows into the HRSG 40 or to the intercooler 33. Water that flows into the intercooler 33 is used to cool the compressed air in the early stages and produce low pressure (LP) steam that then flows into the inlet of the LP turbine 37 along with the LP steam from the HRSG 40. As a result, the compressed air from the second compressor 34 has a lower temperature than without the use of an intercooler and therefore the cooling of the turbine airfoil 16 is improved. The cooling air from the turbine airfoil 16 is then discharged into the combustor 12 to be burned with fuel and produce the hot gas stream for the turbine 13.

We claim the following:

1. An industrial gas turbine engine comprising:
a first compressor to produce a first compressed air with a first pressure;
a combustor to receive the first compressed air from the first compressor to burn with a fuel to produce a hot gas stream;
a turbine rotatably connected to the first compressor to receive the hot gas stream from the combustor;
the turbine having a stator vane with a cooling circuit;
a second compressor to produce a second compressed air with a second pressure;
a first passage to pass the second compressed air from the second compressor to the cooling circuit of the stator vane;
a second passage to pass the second compressed air from the turbine stator vane to the combustor; and,
the second pressure is greater than the first pressure.

2. The industrial gas turbine engine of claim 1, and further comprising:
the second compressor includes an intercooler to lower a temperature of the second compressed air.

3. The industrial gas turbine engine of claim 1, and further comprising:
an inlet to the second compressor is connected to a lower stage of the first compressor; and,
an intercooler is located between the first compressor and the second compressor to lower a temperature of the second compressed air.

4. The industrial gas turbine engine of claim 1, and further comprising:
a heat recovery steam generator to receive exhaust from the turbine of the gas turbine engine and produce steam to drive a second turbine that drives an electric generator;
a condenser to convert exhaust steam from the second turbine into water; and,
the second compressor having an intercooler that uses the water from the condenser to lower a temperature of the second compressed air.
